(19) United States
(12) Patent Application Publication
(10) Pub. No.: US 2026/0277665 A1
(43) Pub. Date: Sep. 17, 2026

(54) SCHEDULING FOR TASK PROCESSING

(71) Applicant: Bytedance Technology Ltd., Grand Cayman (KY)

(72) Inventors: Guoxiang Zhu, Beijing (CN); Wenhao Hu, Beijing (CN); Yangyang Zhang, Beijing (CN); Wei Dai, Beijing (CN)

(21) Appl. No.: 19/080,595

(22) Filed: Mar. 14, 2025

(51) Int. Cl. G06F 9/48

(52) U.S. Cl. CPC G06F 9/4881

(57) ABSTRACT

Embodiments of the disclosure provide a solution for task scheduling. A method includes: obtaining a workflow for processing a task, the workflow comprising a plurality of nodes connected in an order, a node in the plurality of nodes being configured to perform a subtask of the task based on configuration information of the node; in response to a first node of the plurality of nodes being scheduled for processing, extracting first input information for the first node from context information associated with the workflow, the context information being accessible to the plurality of nodes; causing a first subtask to be processed by the first node at least based on the first input information, to obtain a response of the first subtask; and updating the context information based on the response of the first subtask.

### FIELD

The present disclosure generally relates to computer technologies, and more specifically, to a method, apparatus, device and computer readable storage medium for task scheduling.

### BACKGROUND

Recently, applications typically require handling a large number of tasks. There may be a plurality of relationships and constraints between these tasks, making task management and execution more challenging. Specifically, there may be dependencies between tasks, that is, the execution of certain tasks depends on the completion of other tasks. For example, task B may need to wait for task A to complete before starting execution, as the output of task A may be the input of task B, or the execution conditions of task B may depend on the result of task A. A workflow orchestration tool may simplify the orchestration of different tasks.

### SUMMARY

In a first aspect of the present disclosure, there is provided a method for task scheduling. The method comprises: obtaining a workflow for processing a task, the workflow comprising a plurality of nodes connected in an order, a node in the plurality of nodes being configured to perform a subtask of the task based on configuration information of the node; in response to a first node of the plurality of nodes being scheduled for processing, extracting first input information for the first node from context information associated with the workflow, the context information being accessible to the plurality of nodes; causing a first subtask to be processed by the first node at least based on the first input information, to obtain a response of the first subtask; and updating the context information based on the response of the first subtask.

In a second aspect of the present disclosure, there is provided an apparatus for task scheduling. The apparatus comprises: a workflow obtaining module configured to obtain a workflow for processing a task, the workflow comprising a plurality of nodes connected in an order, a node in the plurality of nodes being configured to perform a subtask of the task based on configuration information of the node; and a task processing module configured to, in response to a first node of the plurality of nodes being scheduled for processing, extract first input information for the first node from context information associated with the workflow, the context information being accessible to the plurality of nodes, cause a first subtask to be processed by the first node at least based on the first input information, to obtain a response of the first subtask and update the context information based on the response of the first subtask.

In a third aspect of the present disclosure, there is provided an electronic device. The electronic device comprises: at least one processor; and at least one memory coupled to the at least one processor and storing instructions executable by the at least one processor, the instructions, upon execution by the at least one processor, causing the electronic device to perform: obtaining a workflow for processing a task, the workflow comprising a plurality of nodes connected in an order, a node in the plurality of nodes being configured to perform a subtask of the task based on configuration information of the node; in response to a first node of the plurality of nodes being scheduled for processing, extracting first input information for the first node from context information associated with the workflow, the context information being accessible to the plurality of nodes; causing a first subtask to be processed by the first node at least based on the first input information, to obtain a response of the first subtask; and updating the context information based on the response of the first subtask.

In a fourth aspect of the present disclosure, a computer-readable storage medium is provided. The computer-readable storage medium stores computer executable instructions which, when executed by an electronic device, causes the electronic device perform operations comprising: obtaining a workflow for processing a task, the workflow comprising a plurality of nodes connected in an order, a node in the plurality of nodes being configured to perform a subtask of the task based on configuration information of the node; in response to a first node of the plurality of nodes being scheduled for processing, extracting first input information for the first node from context information associated with the workflow, the context information being accessible to the plurality of nodes; causing a first subtask to be processed by the first node at least based on the first input information, to obtain a response of the first subtask; and updating the context information based on the response of the first subtask.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2A illustrates a schematic diagram of an interaction process between a workflow and context information in accordance with some embodiments of the present disclosure;

FIG. 2B illustrates a schematic diagram of an interaction process between a node and the context information in accordance with some embodiments of the present disclosure;

FIG. 3 illustrates a schematic diagram of a process of enabling a revert flow in the workflow in accordance with some embodiments of the present disclosure;

FIG. 4 illustrates a schematic diagram of a process of inserting a further node into the workflow in accordance with some embodiments of the present disclosure;

FIG. 5 illustrates a schematic diagram of a process of transitioning the state of the node based on both the state machine and the event in accordance with some embodiments of the present disclosure;

FIG. 6 illustrates a schematic diagram of an example process of task scheduling in accordance with some embodiments of the present disclosure;

FIG. 7 illustrates an example flowchart of a process of task scheduling in accordance with some embodiments of the present disclosure;

FIG. 8 illustrates a flowchart of a process for task scheduling in accordance with some embodiments of the present disclosure;

FIG. 9 shows a block diagram of an apparatus for task scheduling in accordance with some embodiments of the present disclosure; and

FIG. 10 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term "including" and similar terms would be appreciated as open inclusion, that is, "including but not limited to". The term "based on" would be appreciated as "at least partially based on". The term "one embodiment" or "the embodiment" would be appreciated as "at least one embodiment". The term "some embodiments" would be appreciated as "at least some embodiments". Other explicit and implicit definitions may also be included below. As used herein, the term "model" can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user’s authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

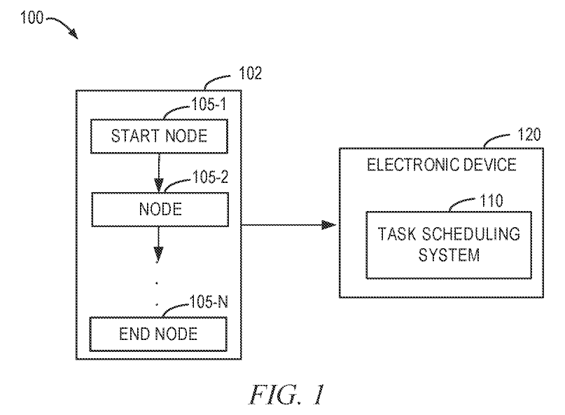

FIG. 1 illustrates a block diagram of an example environment 100 in which various embodiments of the present disclosure may be implemented. In the environment 100, an electronic device 120 includes or is deployed with a task scheduling system 110 configured to orchestrate a workflow. A workflow 102 includes a plurality of nodes 105-1 to 105-N which are configured to process different tasks. Collectively, the workflow 102 may be configured to complete a function or an overall task that encompasses the individual tasks of the nodes 105-1 to 105-N.

The task scheduling system 110 may schedule the plurality of nodes 105-1 to 105-N in an order. In an example, the task scheduling system 110 may firstly schedule node 105-1 and then schedule node 105-2 because input information of the node 105-2 may at least partially rely on output information of the node 105-1.

In the environment 100, the task scheduling system 110 may include any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination 0thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure.

As briefly mentioned above, the orchestration management tool (also referred to as task scheduling system) may be used to orchestrate different tasks. In some solutions, the orchestration management tool may manage the dependencies between tasks to ensure that they are executed in the correct order, and allocate and manage computing resources such as CPU, memory and the like to ensure efficient task execution. In some other solutions, the orchestration management tool may monitor status of task execution in real time and provide detailed running logs.

However, current workflow orchestration tools have some shortcomings. Firstly, some orchestration management tools rely on external tools and message queues to achieve data transfer between nodes. This leads to a complex system architecture of the orchestration management tool, additional configuration and management workload. Consistency, availability and timeliness of data is relied on the external tools instead of the orchestration management tool itself.

Secondly, current workflow orchestration tools focus more on forward process flow and lack support for reverse flow functions, such as task rollback and reverse execution of exception handling paths. For example, when a workflow requires backtracking operations or reverse validation (such as revoking tasks, reviewing processes), these orchestration management tools may not meet the requirement.

Thirdly, current workflow orchestration tools adopt a static workflow definition method, which cannot dynamically adjust nodes during running time of a workflow. For scenarios that require dynamic adjustment of a workflow based on real-time data, external conditions, or unexpected events, this static design is inadequate.

In addition, current workflow orchestration tools only support state driven or event driven implementation, lacking support for the combination of state driven and event driven implementation, which can dynamically adjust the workflow based on the execution status of nodes and external events.

Furthermore, some orchestration management tools are only suitable for specific requirements scenarios and there is still room for improvement in terms of deployment simplicity, real-time support, and versatility. If a requirement involves cross-platform and multi-scenario support, an orchestration management tool may need customized development to satisfy the requirement.

Embodiments of the present disclosure propose an improved solution for task scheduling. In this solution, a workflow for processing a task is obtained. The workflow comprises a plurality of nodes connected in an order. A node in the plurality of nodes is configured to perform a subtask of the task based on configuration information of the node. In response to a first node of the plurality of nodes being scheduled for processing, first input information for the first node is extracted from context information associated with the workflow. The context information is accessible to the plurality of nodes. A first subtask is caused to be processed by the first node at least based on the first input information, to obtain a response of the first subtask. Then, the context information is updated based on the response of the first subtask.

With these embodiments of the present disclosure, context information is maintained and is accessible to all nodes in the workflow. Depending on scheduling and execution of an individual node, input information used for processing a subtask corresponding to the node may be extracted from the context information and the context information may be further updated based on the response of the processed subtask. In this way, the coupling between different nodes may decrease, as they may always interact with the context information to obtain their input information and feedback with their output information. Each node only needs to focus on its own processing instead of communicating with other nodes to retrieve or provide input or output information, thereby improving efficiency in task processing. Further, the node configurations may also be simplified as it may not need to provide interfaces for information retrieval and provision.

Example embodiments of the present disclosure will be described with reference to the drawings.

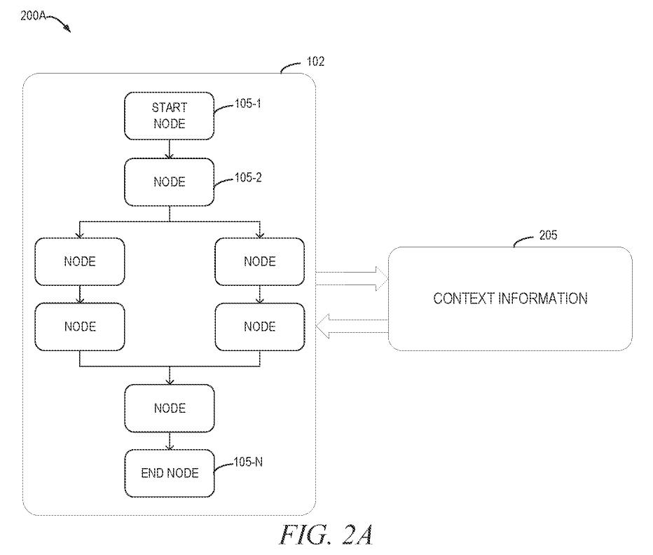

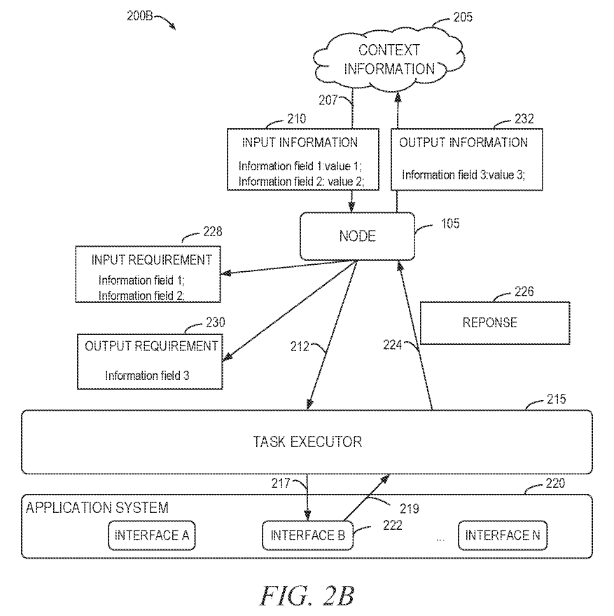

FIG. 2A illustrates a schematic diagram of an interaction process 200A between the workflow 102 and context information in accordance with some embodiments of the present disclosure. As shown in FIG. 2A, the workflow 102 for processing a task is obtained. The workflow 102 may be configured as required to complete any suitable tasks, e.g., uploading a content to a server, recommending a content to a user and the like. The workflow 102 includes the plurality of nodes 105-1 to 105-N connected in an order. A node in the plurality of nodes 105-1 to 105-N is configured to perform a subtask of the task based on configuration information of the node. In an example, if the task processed by the workflow 102 is recommending a content to a user, a subtask performed by a node 105-1 may be training a machine learning model for recommending, and other subtasks for the content recommendations may also be included in the workflow 102. The configuration information of a node may at least configure which subtask to be performed and the invoking path to perform the subtask.

In some embodiments, the plurality of nodes 105-1 to 105-N may access context information 205 to obtain input information for processing respective subtasks and update the context information 205 based on the processing of the respective subtasks. In some examples, the context information 205 may be created and then stored in any suitable storage device or system, e.g., in a cloud environment. The plurality of nodes 105-1 to 105-N may interact with the context information 205 by JsonPath or other custom functions.

The following will introduce how an individual node interacts with the context information 205 with reference to FIG. 2B, which illustrates a schematic diagram of an interaction process 200B between a node 105 and the context information 205 in accordance with some embodiments of the present disclosure. It would be appreciated that the interaction process 200B may be implemented for each node in the workflow.

As shown in FIG. 2B, in response to a node 105 of the workflow 102 being scheduled for processing, at step 207, input information 210 for the node 105-1 is extracted from the context information 205 associated with the workflow 102. The node 105 may be any node of the workflow 102 and the context information 205 is stored in a storage device accessible to the plurality of nodes 105-1 to 105-N. In an example, the context information 205 may include an initialized data set by a party related to the workflow 102 before the processing of the workflow 102. The initialized context information 205 may be updated after the start node of the workflow 102 is scheduled for processing. An example of the context information 205 may be provided, where the context information 205 may include information fields “bookType”, “language” and “result”. The information field “bookType” indicates the type of a book, the information field “language” indicates the language of the book and the information field “result” indicates detailed information of the book.

In some embodiments, configuration information of a node 105 may at least comprise an input requirement (also referred to as input selector) for the node 105. The input requirement may indicate at least one input information field to be extracted from the context information 205. In the example of FIG. 2B, it is illustrated that input requirement 228 for the node 105 may indicate two information fields to be extracted from the context information 205. An example of the input requirement 228 may be provided, where information fields “bookType” and “language” are required as input for the node 105.

After obtaining the input requirement 228, information of the two information fields indicated by the configuration information of the node 105 may be extracted from the context information 205 as the input information 210 of the node 105. An example of the input information 210 extracted from the context information 205 is provided, where information of the information field “bookType” is “novels” and information of the information field “language” is “English”.

After extracting the input information 210, a subtask of the node 105 may be caused to be processed by the node 105 based on the input information 210, to obtain a response 226 of the subtask. In some embodiments, the response 226 may be obtained based on an external system. In an example, at step 212, the node 105-1 may transmit the input information 210 to a task executor 215. At step 217, the task executor 215 may invoke an interface B 222 included in an application system (as an example of the external system) 220. The interface B 222 may specify an input of a function and an output of the function, where the function may be configured to process the subtask. At step 219, the task executor 215 may receive the response 226 from the interface 222. At step 224, the task executor 215 may transmit the response 226 to the node 105.

In an example, based on the input information 210, the subtask of the node 105 is to retrieve information of books whose type is novel, and language of publication is English. The interface B 222 may be configured to retrieve information of a book given the type of the book and the language of the book. The task executor 215 may invoke the interface B 222 to process the subtask by providing the type of the book (i.e. “novel”) and the language of the book (“English”) to the interface B 222. As a result, the interface B 222 may provide the response 226 of the subtask, that is detailed information of books whose type is novel, and language of publication is English. An example of the response 226 may be provided, where items of the books are retrieved in the response 226. An item includes the title and the author of the book.

In some embodiments, besides the input information 210 extracted from the context information 205, input information of the node 105-1 may further include second input information (not shown) specific to the node 105-1 input by a user. In some examples, the user may input information to the node 105-1 based on the subtask processed by the node 105-1. If the subtask processed by the node 105-1 is training machine learning models, the user may input training strategies to the node 105-1. After obtaining the second input information, the subtask may be caused to be processed by the node 105-1 based on the input information 210 and the second input information. In this way, the node may provide customized content or services based on user input data, thereby causing the node to meet different requirements.

After obtaining the response 226, the context information 205 is updated based on the response 226. In some embodiments, a part of the response 226 which are used by other nodes in the plurality of nodes 105-1 to 105-N may be merged into the context information 205. In this way, the context information is updated dynamically, thereby ensuring each node in the workflow may obtain the latest information for task processing.

In some embodiments, configuration information of the node 105 may at least comprise an output requirement (also referred to as output selector) for the node. The output requirement may indicate at least one output information field to be updated into the context information 205. In the example of FIG. 2B, output requirement 230 for the node 105-1 may indicate an information field to be extracted from the context information 205. An example of the output requirement 230 may be provided, where an information filed “item” indicates items of books.

Then, based on the output requirement 230, information of the indicated information field may be determined from the response 226 as output information 232 of the node 105. An example of the output information 232 may be provided, where information of the information field “item” is determined from the response 226. The information of the information field “item” includes the title and author of books whose type is novel, and language of publication is English.

After obtaining the output information 232 of the node 105, the context information 205 may be updated with the output information 232. The updated context information 205 may be provided, where the updated context information 205 includes the output information 232.

In some embodiments, the output requirement 230 may further be determined based on requirements for input information of other downstream nodes in the plurality of nodes 105-1 to 105-N. In this way, the output information 232 updated into the context information 205 is useful for the other nodes.

In some embodiments, other nodes of the workflow 102 connected after the node 105 may continue to process respective tasks according to the process 200B. In this way, different nodes share information by the context information rather than interacting with each other directly, thereby improving the efficiency of exchanging data between nodes.

In some embodiments, the plurality of nodes 105 may be scheduled in parallel to process respective tasks. In some embodiments, if input information for a node cannot be extracted from the context information 205 when the node is scheduled, it may indicate that other nodes have not updated the required information into the context information 205. The node may wait for some time and then attempt to extract the input information from the context information again.

In some embodiments, a revert flow may be enabled in the workflow 102. In order to achieve the revert flow, respective rollback functions may be configured for the plurality of nodes 105-1 to 105-N. A rollback function for a node is configured to roll back a subtask that has been processed by the node. In an example, a subtask processed by a node is to store data into a database. The rollback function for the node is to remove the stored data from the database.

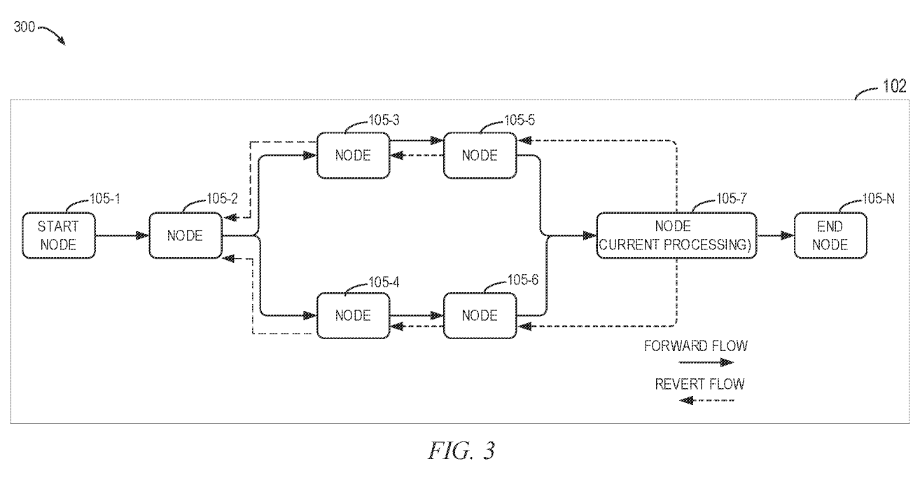

FIG. 3 illustrates a schematic diagram of a process 300A of enabling a revert flow in the workflow 102 in accordance with some embodiments of the present disclosure. As shown in FIG. 3, the node 105-2 may be determined as the node whose completed subtask needs to be rolled back based on user input or an event. In an example, a user may click a button to roll back the subtask processed by the node 105-2. In another example, some errors that happened in the workflow 102 may indicate the subtask processed by the node 105-2 needs to be rolled back. In response to a trigger of rollback at the node 105-2 (also referred to as third node), at least one node from a node that is currently processing a subtask (also referred to as fourth node, i.e., node 105-7) to the node 105-2 may be controlled to perform at least one rollback function for the at least one node. In other words, at least one node of the node 105-3, 105-4, 105-5 and 105-6 may be controlled to perform rollback functions. In this way, by providing the rollback function for different nodes, data consistency and data integrity may be guaranteed, thereby providing a more reliable, flexible and error-tolerant workflow.

In some embodiments, a rollback function for a node may be configured in a template of the node. In some examples, a template of a node may be provided, where a forwardTask function defines processing of a subtask and a rollbackTask function defines a roll back function corresponding to the subtask.

The node currently processing a subtask may be determined based on the current execution state of a workflow 102. An example of current execution state of a workflow may be provided, where Node 1 and Node 2 have completed their corresponding subtask, and Node 3 is processing its corresponding subtask. Therefore, Node 3 is the node currently processing the subtask.

In some examples, from the node (i.e., node 3) currently processing a subtask to a node (i.e., node 2) whose completed subtask needs to be rolled back, the rollback function of each node may be invoked, so that the revert flow is enabled in the workflow.

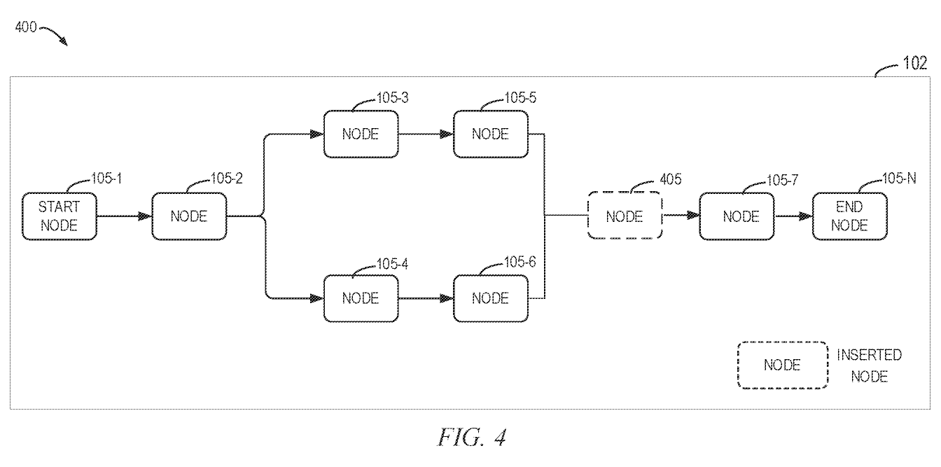

The following will describe dynamical inserting of an additional node(s) into the workflow 102 with reference to FIG. 4, which illustrates a schematic diagram of a process 400 of inserting a further node into the workflow 102 in accordance with some embodiments of the present disclosure. As shown in FIG. 4, node 405 (also referred to as further node) may be inserted into the workflow 102 during runtime of the workflow 102 based on information associated with node 105-6 (also referred to as fifth node) currently processing a subtask. The node 405 may be configured to process a further task. In this way, the flexibility and adaptability of workflow may be improved.

In some embodiments, the information associated with the node 105-6 may include configuration information (e.g., a template) of the node 105-6. The configuration information may include conditional information for node insertion configured for the node 105-6 and a position of inserting the node 105-6. An example configuration information of the node 105-6 may be provided, where the example configuration information may indicate the conditional information for node insertion, the position of inserting the node 405, the information of the node 105-6, the configuration of the node 405 (e.g., a task to be processed by the node 405).

Whether the conditional information is satisfied may be determined based on runtime information of the node 105-6. In an example, runtime information of the node 105-6 may be obtained from the context information 205. Then, the node 405 may be inserted into the workflow 102 at the configured position (i.e., before node 105-7 and after node 105-6) in response to determining that the conditional information is satisfied.

In some embodiments, the information associated with the node 105-6 may include a position of inserting the node 405 in the workflow 102 and a response of a subtask of the node 105-6. Whether the node 405 is to be inserted may be determined based on the response of the subtask of the node 105-6. Then, the node 405 may be inserted into the workflow 102 at the configured position (e.g., before node 105-7 and after node 105-6) in response to determining that the further node is to be inserted.

In some embodiments, the context information 205 may further comprise respective states of respective nodes in the plurality of nodes. The context information 205 may be updated with respective states of the respective nodes in response to respective nodes being scheduled or completed. A state of a node indicates whether a subtask of the node is one of: pending, in-progress, completed or failed. The state of pending indicates that a node has not started to process a task. The state of in-progress indicates that a node is processing the task. The state of completed indicates that a node has completed the processing of the task. The state of failed indicates that there is an error during the processing of the task. By recording states of respective nodes in the context information, the progress of the workflow may be tracked in real-time and resources may be allocated to different nodes more reasonably, thereby improving efficiency in task processing.

Alternatively, or in addition, the context information 205 may be updated with respective states of the respective nodes in response to respective nodes being rolled back. An example of statuses of nodes in the context information may be provided, where the status of node 1 may be recorded as completed, the status of node 2 and node 3 may be recorded as rolled back, and the status of node 4 may be recorded as pending.

In some embodiments, the state of the node may be transitioned based on at least one of a state machine or an event. In some examples, the state of the node is only transitioned based on the state machine. The state machine may specify a transition rule the state of the node. For example, the state of the node is in-progress and if a subtask is successfully processed by the node, the state of the node may be transitioned to completed. The state of the node is pending and if the node starts to process the subtask, the state of the node may be transitioned to in-progress. The state of the node is in-progress and if some errors happen when the node processes the subtask, the state of the node may transition to be failed.

In some examples, the state of the node is only transitioned based on the event. When an event triggers, the state of the node may be modified. In another example, the state of the node is transitioned based on both the state machine and the event. When a node is transitioned to the state of completed, a specific event may be monitored. When the specific event is triggered, the state of the node may be modified. Furthermore, when the specific event is triggered, some operations may be performed, such as rerunning the node.

FIG. 5 illustrates a schematic diagram of a process 500 of transitioning the state of the node based on both the state machine and the event in accordance with some embodiments of the present disclosure. As shown in FIG. 5, the state of node 105-1 and node 105-2 are transitioned based on the state machine. The states of node 105-3 to node 105-5 are transitioned based on the event.

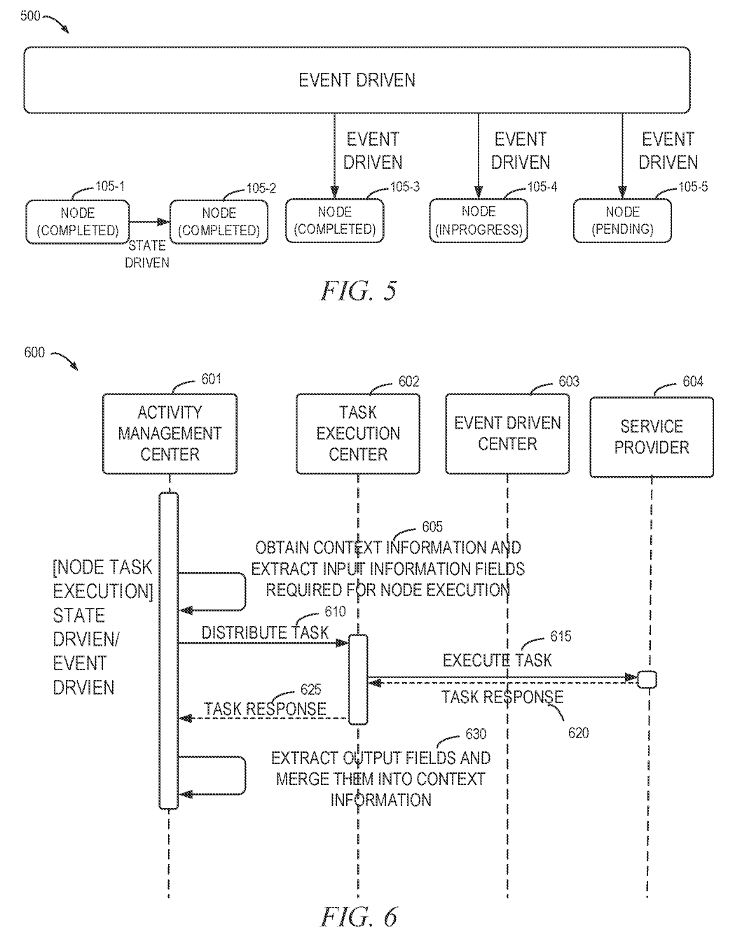

FIG. 6 illustrates a schematic diagram of an example process 600 of task scheduling in accordance with some embodiments of the present disclosure. As shown in FIG. 6, the task scheduling system 110 may include an activity management center 601, a task execution center 602 and an event driven center 603. A service provider 604 may be configured to execute different tasks. At step 605, the activity management center 601 may obtain context information, and extract input information of input information fields required for a node. In an example, the input information fields may be indicated in an input requirement in configuration information of the node.

At step 610, the activity management center 601 may distribute the task of node to the task execution center 602. In addition, the activity management center 601 may provide the input information to the task execution center 602. At step 615, the task execution center 602 may invoke an interface of the service provider 604 to execute the task.

At step 620, the service provider 604 may provide a task response to the task execution center 602. At step 625, the task execution center 602 may provide the task response to the activity management center 601.

At step 630, the activity management center 601 may extract output information of output information fields and merge the output information into the context information. In an example, the output information fields may be indicated in an output requirement in configuration information of the node.

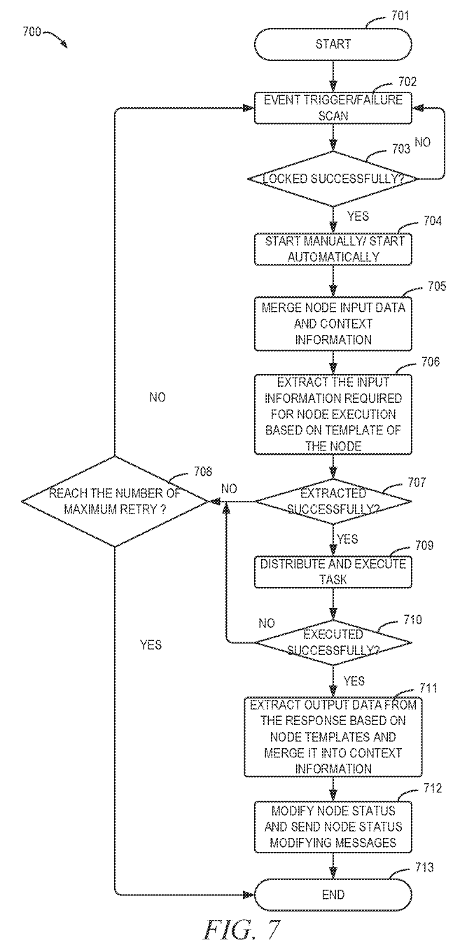

FIG. 7 illustrates an example flowchart of a process 700 of task scheduling in accordance with some embodiments of the present disclosure. As shown in FIG. 7, at block 701, the process 700 starts. At block 702, an event is triggered so that a node may be scheduled to process a task. At block 703, whether the node is locked successfully may be determined. If the process of the node is not locked successfully, the process 700 may return to block 702 to scan the failure of the lock. Otherwise, the process 700 may proceed to block 704. At block 704, the node may be started to process the task manually or automatically.

At block 705, user-input data specific to the node and context information may be merged. At block 706, input information required for a node may be extracted from the merged information based on a template of the node. In an example, the template may include an input requirement for the node and the input requirement indicates at least one input information field to be extracted. At block 707, whether the input information is extracted successfully may be determined. If the input information is not extracted successfully, the process 700 may proceed to block 708. At block 708, whether the number of maximum retry is reached may be determined. If the number of maximum retry is reached, the process 700 may proceed to block 713 where the process 700 ends. Otherwise, the process 700 may return to the block 702.

If the input information is extracted successfully, the process 700 may proceed to block 709. At block 709, the task may be distributed and executed. In an example, the task may be distributed and executed by invoking an application programming interface (API). At block 710, whether the task is executed successfully may be determined.

If the task is not executed successfully, the process 700 may return to block 708. Otherwise, process 700 may proceed to block 711. At block 711, output information of the node may be extracted from the response of the node based on the template of the node and the output data may be merged into the context information. In an example, the template may include an output requirement for the node and the output requirement indicates at least one output information field to be merged. At block 712, the state of the node may be modified and a message of the modifying the state of the node may be sent. At block 713, the process 700 ends.

FIG. 8 illustrates a flowchart of a process 800 for task scheduling in accordance with some embodiments of the present disclosure. The process 800 may be implemented at the task scheduling system 110 of FIG. 1.

At block 810, the task scheduling system 110 obtains a workflow for processing a task, the workflow comprising a plurality of nodes connected in an order, a node in the plurality of nodes being configured to perform a subtask of the task based on configuration information of the node.

At block 820, in response to a first node of the plurality of nodes being scheduled for processing, the task scheduling system 110 extracts first input information for the first node from context information associated with the workflow, the context information being accessible to the plurality of nodes, causes a first subtask to be processed by the first node at least based on the first input information, to obtain a response of the first subtask and updates the context information based on the response of the first subtask.

In some embodiments, configuration information of a node in the plurality of nodes at least comprises an input requirement for the node, the input requirement indicating at least one input information field to be extracted from the context information, and extracting the first input information comprises: extracting, from the context information, information of at least one input information field indicated by first configuration information of the first node, as the first input information of the first node.

In some embodiments, configuration information of a node in the plurality of nodes at least comprises an output requirement for the node, the output requirement indicating at least one output information field to be updated into the context information, and updating the context information comprises: determining, from the response of the first subtask, information of at least one output information field indicated by first configuration information of the first node, as output information of the first node; and updating the context information with the output information of the first node.

In some embodiments, causing the first subtask to be processed comprises: obtaining a second input information specific to the first node input by a user; and causing the first subtask to be processed by the first node based on the first input information and the second input information.

In some embodiments, the process 800 further comprises: in response to a second node connected after the first node being scheduled for processing, extracting second input information for the second node from the updated context information; causing a second subtask to be processed by the second node at least based on the second input information, to obtain a response of the second subtask; and further updating the context information based on the response of the second subtask.

In some embodiments, the process 800 further comprises: configuring respective rollback functions for the plurality of nodes, a rollback function for a node being configured to roll back a subtask that has been processed by the node; in response to a trigger of rollback at a third node of the plurality of nodes, controlling at least one node from a fourth node that is currently processing a subtask to the third node to perform at least one rollback function for the at least one node.

In some embodiments, the context information further comprises respective states of respective nodes in the plurality of nodes and the method further comprises: updating the context information with respective states of the respective nodes in response to respective nodes being scheduled or completed, wherein a state of a node indicates whether a subtask of the node is one of: pending, in-progress, completed or failed.

In some embodiments, the state of the node is transitioned based on at least one of a state machine or an event.

In some embodiments, the process 800 further comprises: inserting a further node into the workflow during runtime of the workflow based on information associated with a fifth node currently processing a subtask, the further node being configured to process a further task.

In some embodiments, the information associated with the fifth node comprises conditional information for node insertion configured for the fifth node, and a position of inserting the further node in the workflow configured in configuration information of the fifth node, and inserting the further node comprises: determining whether the conditional information is satisfied based on runtime information of the fifth node; and inserting the further node into the workflow at the configured position in response to determining that the conditional information is satisfied.

In some embodiments, the information associated with the fifth node comprises a position of inserting the further node in the workflow configured in configuration information of the fifth node and a response of a subtask of the fifth node, and inserting the further node comprises: determining, based on the response of the subtask of the fifth node, whether the further node is to be inserted; and inserting the further node into the workflow at the configured position in response to determining that the further node is to be inserted.

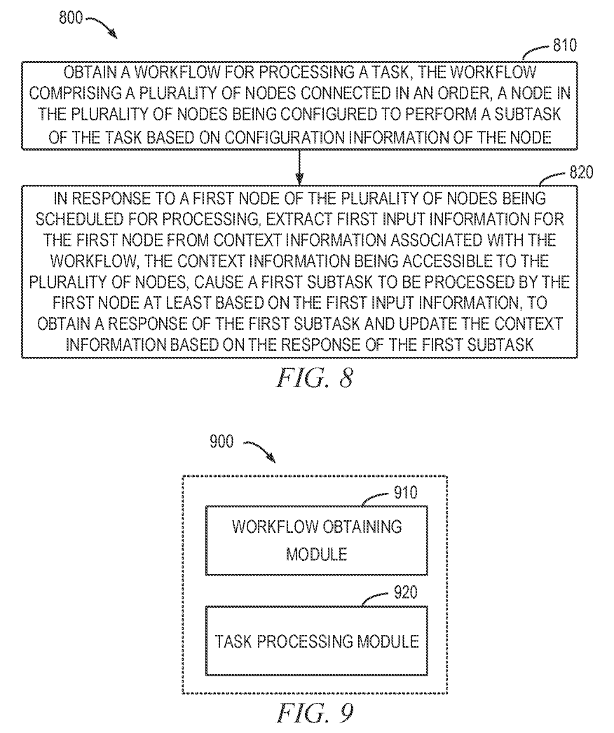

FIG. 9 shows a block diagram of an apparatus 900 for task scheduling in accordance with some embodiments of the present disclosure. The apparatus 900 may be implemented, for example, or included at the task scheduling system 110 of FIG. 1. Various modules/components in the apparatus 900 may be implemented by hardware, software, firmware, or any combination thereof.

As shown, the apparatus 900 includes a workflow obtaining module 910 configured to obtain a workflow for processing a task, the workflow comprising a plurality of nodes connected in an order, a node in the plurality of nodes being configured to perform a subtask of the task based on configuration information of the node.

The apparatus 900 further includes a task processing module 920 configured to, in response to a first node of the plurality of nodes being scheduled for processing, extract first input information for the first node from context information associated with the workflow, the context information being accessible to the plurality of nodes, cause a first subtask to be processed by the first node at least based on the first input information, to obtain a response of the first subtask and update the context information based on the response of the first subtask.

In some embodiments, configuration information of a node in the plurality of nodes at least comprises an input requirement for the node, the input requirement indicating at least one input information field to be extracted from the context information. The task processing module 920 is further configured to extract, from the context information, information of at least one input information field indicated by first configuration information of the first node, as the first input information of the first node.

In some embodiments, configuration information of a node in the plurality of nodes at least comprises an output requirement for the node, the output requirement indicating at least one output information field to be updated into the context information. The task processing module 920 is further configured to determine, from the response of the first subtask, information of at least one output information field indicated by first configuration information of the first node, as output information of the first node and update the context information with the output information of the first node.

In some embodiments, the task processing module 920 is further configured to obtain a second input information specific to the first node input by a user and cause the first subtask to be processed by the first node based on the first input information and the second input information.

In some embodiments, the apparatus 900 further includes a second task processing module configured to, in response to a second node connected after the first node being scheduled for processing, extract second input information for the second node from the updated context information, cause a second subtask to be processed by the second node at least based on the second input information, to obtain a response of the second subtask and further update the context information based on the response of the second subtask.

In some embodiments, the apparatus 900 further includes a rollback module configured to configure respective rollback functions for the plurality of nodes, a rollback function for a node being configured to roll back a subtask that has been processed by the node, in response to a trigger of rollback at a third node of the plurality of nodes, control at least one node from a fourth node that is currently processing a subtask to the third node to perform at least one rollback function for the at least one node.

In some embodiments, the context information further comprises respective states of respective nodes in the plurality of nodes. The apparatus 900 further includes a state updating module configured to update the context information with respective states of the respective nodes in response to respective nodes being scheduled or completed, wherein a state of a node indicates whether a subtask of the node is one of: pending, in-progress, completed or failed.

In some embodiments, the state of the node is transitioned based on at least one of a state machine or an event.

In some embodiments, the apparatus 900 further includes a node inserting module configured to insert a further node into the workflow during runtime of the workflow based on information associated with a fifth node currently processing a subtask, the further node being configured to process a further task.

In some embodiments, the information associated with the fifth node comprises conditional information for node insertion configured for the fifth node, and a position of inserting the further node in the workflow configured in configuration information of the fifth node. The node inserting module is further configured to determine whether the conditional information is satisfied based on runtime information of the fifth node and insert the further node into the workflow at the configured position in response to determining that the conditional information is satisfied.

In some embodiments, the information associated with the fifth node comprises a position of inserting the further node in the workflow configured in configuration information of the fifth node and a response of a subtask of the fifth node. The node inserting module is further configured to determine, based on the response of the subtask of the fifth node, whether the further node is to be inserted and insert the further node into the workflow at the configured position in response to determining that the further node is to be inserted.

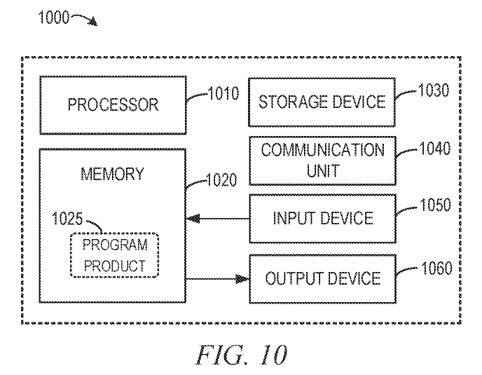

FIG. 10 illustrates a block diagram of an electronic device 1000 in which one or more embodiments of the present disclosure can be implemented. It would be appreciated that the electronic device 1000 shown in FIG. 10 is only an example and should not constitute any restriction on the function and scope of the embodiments described herein. The electronic device 1000 may be used, for example, to implement the task scheduling system 110 of FIG. 1. The electronic device 1000 may also be used to implement the apparatus 900 of FIG. 9.

As shown in FIG. 10, the electronic device 1000 is in the form of a general computing device. The components of the electronic device 1000 may include, but are not limited to, one or more processing units or processors 1010, a memory 1020, a storage device 1030, one or more communication units 1040, one or more input devices 1050, and one or more output devices 1060. The processor 1010 may be an actual or virtual processor and can execute various processes according to the programs stored in the memory 1020. In a multiprocessor system, multiple processing units execute computer executable instructions in parallel to improve the parallel processing capability of the electronic device 1000.

The electronic device 1000 typically includes a variety of computer storage medium. Such medium may be any available medium that is accessible to the electronic device 1000, including but not limited to volatile and non-volatile medium, removable and non-removable medium. The memory 1020 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 1030 may be any removable or non-removable medium, and may include a machine-readable medium, such as a flash drive, a disk, or any other medium, which can be used to store information and/or data (such as context information) and can be accessed within the electronic device 1000.

The electronic device 1000 may further include additional removable/non-removable, volatile/non-volatile, transitory/non-transitory storage medium. Although not shown in FIG. 10, a disk driver for reading from or writing to a removable, non-volatile disk (such as a "floppy disk"), and an optical disk driver for reading from or writing to a removable, non-volatile optical disk can be provided. In these cases, each driver may be connected to the bus (not shown) by one or more data medium interfaces. The memory 1020 may include a computer program product 1025, which has one or more program modules configured to perform various methods or acts of various embodiments of the present disclosure.

The communication unit 1040 communicates with a further computing device through the communication medium. In addition, functions of components in the electronic device 1000 may be implemented by a single computing cluster or multiple computing machines, which can communicate through a communication connection. Therefore, the electronic device 1000 may be operated in a networking environment using a logical connection with one or more other servers, a network personal computer (PC), or another network node.

The input device 1050 may be one or more input devices, such as a mouse, a keyboard, a trackball, etc. The output device 1060 may be one or more output devices, such as a display, a speaker, a printer, etc. The electronic device 1000 may also communicate with one or more external devices (not shown) through the communication unit 1040 as required. The external device, such as a storage device, a display device, etc., communicate with one or more devices that enable users to interact with the electronic device 1000, or communicate with any device (for example, a network card, a modem, etc.) that makes the electronic device 1000 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for task scheduling, comprising:
obtaining a workflow for processing a task, the workflow comprising a plurality of nodes connected in an order, a node in the plurality of nodes being configured to perform a subtask of the task based on configuration information of the node;
in response to a first node of the plurality of nodes being scheduled for processing,
extracting first input information for the first node from context information associated with the workflow, the context information being accessible to the plurality of nodes;
causing a first subtask to be processed by the first node at least based on the first input information, to obtain a response of the first subtask; and
updating the context information based on the response of the first subtask.

2. The method of claim 1, wherein configuration information of a node in the plurality of nodes at least comprises an input requirement for the node, the input requirement indicating at least one input information field to be extracted from the context information, and extracting the first input information comprises:
extracting, from the context information, information of at least one input information field indicated by first configuration information of the first node, as the first input information of the first node.

3. The method of claim 1, wherein configuration information of a node in the plurality of nodes at least comprises an output requirement for the node, the output requirement indicating at least one output information field to be updated into the context information, and updating the context information comprises:
determining, from the response of the first subtask, information of at least one output information field indicated by first configuration information of the first node, as output information of the first node; and
updating the context information with the output information of the first node.

4. The method of claim 1, wherein causing the first subtask to be processed comprises:
obtaining a second input information specific to the first node input by a user; and
causing the first subtask to be processed by the first node based on the first input information and the second input information.

5. The method of claim 1, further comprising:
in response to a second node connected after the first node being scheduled for processing,
extracting second input information for the second node from the updated context information;
causing a second subtask to be processed by the second node at least based on the second input information, to obtain a response of the second subtask; and
further updating the context information based on the response of the second subtask.

6. The method of claim 1, further comprising:
configuring respective rollback functions for the plurality of nodes, a rollback function for a node being configured to roll back a subtask that has been processed by the node;
in response to a trigger of rollback at a third node of the plurality of nodes,
controlling at least one node from a fourth node that is currently processing a subtask to the third node to perform at least one rollback function for the at least one node.

7. The method of claim 1, wherein the context information further comprises respective states of respective nodes in the plurality of nodes and the method further comprises:
updating the context information with respective states of the respective nodes in response to respective nodes being scheduled or completed, wherein a state of a node indicates whether a subtask of the node is one of: pending, in-progress, completed or failed.

8. The method of claim 7, wherein the state of the node is transitioned based on at least one of a state machine or an event.

9. The method of claim 1, further comprising:
inserting a further node into the workflow during runtime of the workflow based on information associated with a fifth node currently processing a subtask, the further node being configured to process a further task.

10. The method of claim 9, wherein the information associated with the fifth node comprises conditional information for node insertion configured for the fifth node, and a position of inserting the further node in the workflow configured in configuration information of the fifth node, and inserting the further node comprises:
determining whether the conditional information is satisfied based on runtime information of the fifth node; and
inserting the further node into the workflow at the configured position in response to determining that the conditional information is satisfied.

11. The method of claim 9, wherein the information associated with the fifth node comprises a position of inserting the further node in the workflow configured in configuration information of the fifth node and a response of a subtask of the fifth node, and inserting the further node comprises:
determining, based on the response of the subtask of the fifth node, whether the further node is to be inserted; and
inserting the further node into the workflow at the configured position in response to determining that the further node is to be inserted.

12. An electronic device, comprising:
at least one processor; and
at least one memory coupled to the at least one processor and storing instructions executable by the at least one processor, the instructions, upon execution by the at least one processor, causing the electronic device to perform operations comprising:
obtaining a workflow for processing a task, the workflow comprising a plurality of nodes connected in an order, a node in the plurality of nodes being configured to perform a subtask of the task based on configuration information of the node;
in response to a first node of the plurality of nodes being scheduled for processing,
extracting first input information for the first node from context information associated with the workflow, the context information being accessible to the plurality of nodes;
causing a first subtask to be processed by the first node at least based on the first input information, to obtain a response of the first subtask; and
updating the context information based on the response of the first subtask.

13. The electronic device of claim 12, wherein configuration information of a node in the plurality of nodes at least comprises an input requirement for the node, the input requirement indicating at least one input information field to be extracted from the context information, and extracting the first input information comprises:
extracting, from the context information, information of at least one input information field indicated by first configuration information of the first node, as the first input information of the first node.

14. The electronic device of claim 12, wherein configuration information of a node in the plurality of nodes at least comprises an output requirement for the node, the output requirement indicating at least one output information field to be updated into the context information, and updating the context information comprises:
determining, from the response of the first subtask, information of at least one output information field indicated by first configuration information of the first node, as output information of the first node; and
updating the context information with the output information of the first node.

15. The electronic device of claim 12, wherein causing the first subtask to be processed comprises:
obtaining a second input information specific to the first node input by a user; and
causing the first subtask to be processed by the first node based on the first input information and the second input information.

16. The electronic device of claim 12, the operations further comprising:
in response to a second node connected after the first node being scheduled for processing,
extracting second input information for the second node from the updated context information;
causing a second subtask to be processed by the second node at least based on the second input information, to obtain a response of the second subtask; and
further updating the context information based on the response of the second subtask.

17. The electronic device of claim 12, the operations further comprising:
configuring respective rollback functions for the plurality of nodes, a rollback function for a node being configured to roll back a subtask that has been processed by the node;
in response to a trigger of rollback at a third node of the plurality of nodes,
controlling at least one node from a fourth node that is currently processing a subtask to the third node to perform at least one rollback function for the at least one node.

18. The electronic device of claim 12, wherein the context information further comprises respective states of respective nodes in the plurality of nodes and the method further comprises:
updating the context information with respective states of the respective nodes in response to respective nodes being scheduled or completed, wherein a state of a node indicates whether a subtask of the node is one of: pending, in-progress, completed or failed.

19. The electronic device of claim 18, wherein the state of the node is transitioned based on at least one of a state machine or an event.

20. A non-transitory computer readable storage medium having computer executable instructions stored thereon, the computer executable instructions, when executed by an electronic device, causing the electronic device perform operations comprising:
obtaining a workflow for processing a task, the workflow comprising a plurality of nodes connected in an order, a node in the plurality of nodes being configured to perform a subtask of the task based on configuration information of the node;
in response to a first node of the plurality of nodes being scheduled for processing,
extracting first input information for the first node from context information associated with the workflow, the context information being accessible to the plurality of nodes;
causing a first subtask to be processed by the first node at least based on the first input information, to obtain a response of the first subtask; and
updating the context information based on the response of the first subtask.
